(19) United States
(12) Patent Application Publication
(10) Pub. No.: US 2005/0041685 A1
(43) Pub. Date: Feb. 24, 2005

(54) Highly programmable MAC architecture for handling protocols that require precision timing and demand very short response times

(76) Inventors: Oleg Logvinov, East Brunswick, NJ (US); Fred Skalka, Yardley, PA (US)

Correspondence Address: James E. Reeber;Enikia LLC, 948 US Highway 22, North Plainfield, NJ, 07060, US

(21) Appl. No.: 10/697,629

(22) Filed: Oct. 29, 2003

Related U.S. Application Data
(60) Provisional application No. 60/422,026, filed on Oct. 29, 2002.

(51) Int. Cl. H04J 3/16

(52) U.S. Cl. 370/466

(57) ABSTRACT

This invention defines a highly programmable MAC architecture for handling protocols that require precision timing and demand very short response times. The Media Access Controller consists of micro-coded programmable co-processors and general purpose CPUs. CPUs perform processing intensive functions while co-processors perform PHY specific media access control functions. The uniqueness of the architecture is in the real-time programmability of the co-processors; they can be reprogrammed by the CPUs based on the calculations performed in the CPU domain. Any embodiment of this invention is suitable for ASIC, FPGA, discrete or combinations of these implementation schemes. The invention applies to any communications technology.

### CROSS REFERENCE TO RELATED APPLICATION

This application claims the benefit of U.S. Provisional Appln. No. 60/422,026 filed Oct. 29, 2002, which is incorporated by reference herein.

### FIELD

The present invention relates to data communication systems at the MAC/PHY layer.

### BACKGROUND

Powerline communications (PLC) was selected as an exemplary technology that will be used for illustrative purpose only and it is important to realize that any data communications technology could take advantage of this invention. The use of PLC technology is very attractive because there is no need to install new wires to communicate between stations. Existing power wiring in homes and business as well as the wires used to carry power in the electric power distribution grid are all capable of supporting high-speed data communications. In addition to in-home and access, another key application segment for PLC is multiple dwelling units (MDU) or multiple tenant units (MTU) such as apartment buildings, hotels and motels.

Each of these different application areas represents a different set of design parameters, but all use a MAC/PHY layer in their transceivers. Each of these different areas is in a different standardization condition and government regulatory stage. In-home PLC standardization, for one example, is well along with the formation of an industrial alliance (HomePlug^{[1]}) and the subsequent release of their formal PLC specification. Other segments of PLC applications, such as access, are just starting to become established^{[3]} and so the specifications are more fluid.

Using a flexible and programmable architecture for the design of the MAC/PHY layer in transceivers for each of these applications segments would be highly desirable. The programmable flexibility would mean that changes in standards, regulatory requirements, product patches, new product features and product enhancements could mostly be accommodated by installing new software instead of with costly and time consuming hardware modifications (e.g., revising ASIC logic usually means manufacturing a new very expensive foundry mask set for the device).

### SUMMARY

This invention provides a MAC/PHY layer controller (heretofore referred to as the HardMAC) that interfaces between a general-purpose processor and hardwired DSP logic. The HardMAC performs tasks whose functions are well defined and are, generally too fast for the processor to perform. The HardMAC controls the hardwired DSP logic in such a way as to simplify and generalize the operation of the logic.

In accordance with one embodiment of the present invention, a communications transceiver includes a programmable MAC/PHY layer controller (HardMAC) module coupled to a microprocessor and DSP hardware. The HardMAC preferably is a programmable coprocessor module including pre-defined operation hardware blocks having parameterized functions whose parameter values are programmable. In a preferred embodiment, a portion of the coprocessor module controls timing and the clock cycle rate is a programmable parameter. The programmability of the HardMAC avoids the necessity to make hardware changes involving pre-defined operations performed at a communications transceiver whose parameters may vary based on changes on regulatory requirements or the like.

Thus, a MAC/PHY layer controller is constructed out of three types of blocks: highly flexible general-purpose processor software, very flexible parameterized coprocessor and hardwired DSP logic. The composite PHY function is composed of part of the HardMAC controller and hardwired DSP logic. The composite MAC is composed of general-purpose processor code and a part of the HardMAC. This level of application specific flexibility accommodates a wide variety of alterations including changes to meet new regulatory requirements, solutions to eliminate errors in the operation of the system, and updates for end-product enhancements.

### BRIEF DESCRIPTION OF THE FIGURES

FIG. 1 shows an example of how the device might fit in an overall system;

FIG. 2 shows an example of the primary internal blocks for a device;

FIG. 3 is an example of a detailed block diagram of HardMAC internal interconnections, and also shows command sequencer modules (#400 and 405).

### DETAILED DESCRIPTION

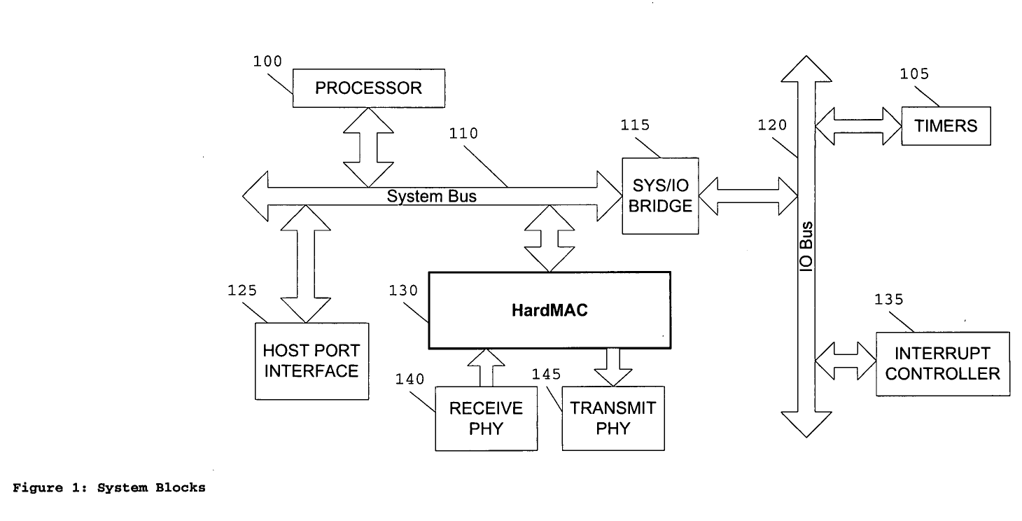

It is noted here that PLC technology is used in this disclosure to help illustrate details of the invention and is by no means the only technology that the invention can be applied to, but can generally be used with any communications technology. A system level view of data communications systems components is shown in FIG. 1. The HardMAC (#130) provides a flexible interface between software (heretofore referred to as the SoftMAC) running on the general-purpose processor (#100) and the hardwired DSP logic (#140 and #145) to create a complete MAC and PHY function. The highly programmable nature of the processor and the flexible nature of the HardMAC combine to create a MAC/PHY layer that is flexible and can be adapted for various needs without restructuring the system.

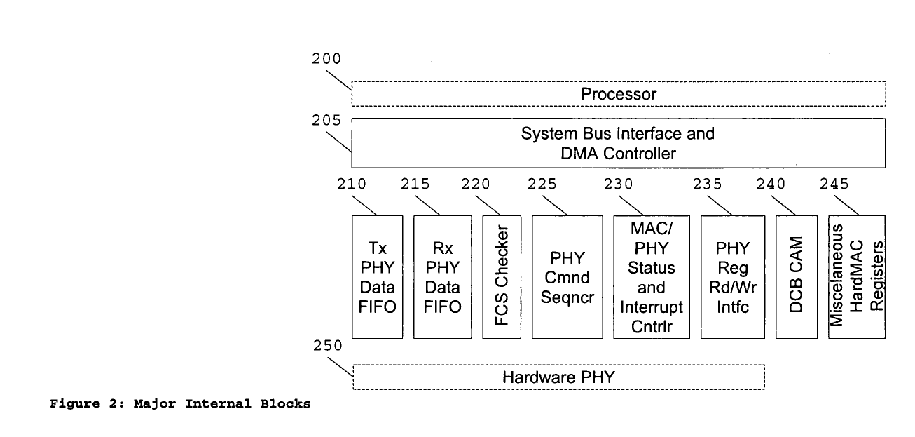

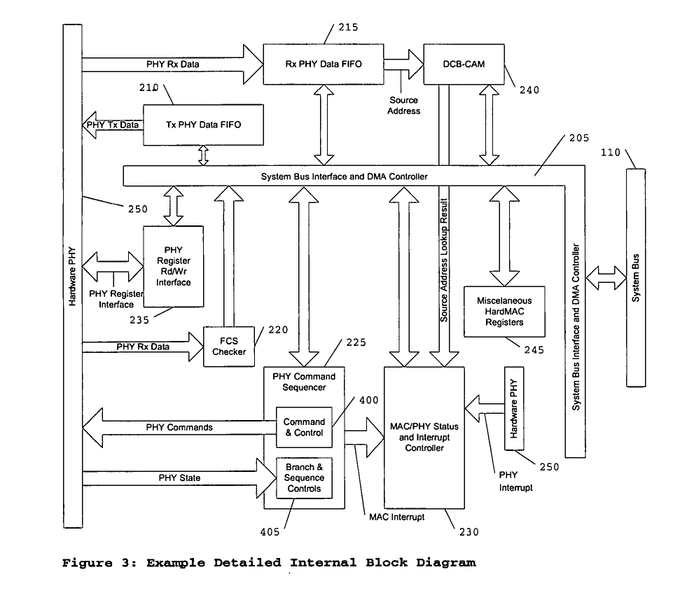

There are nine (9) major blocks within the HardMAC as shown in FIG. 2. The System bus (#205) interfaces to the processor (#200) while the hardware PHY logic (#250) interfaces to the six (6) blocks (#210, #215, #220, #225, #230, and #235) as shown. The detailed interconnections between blocks are shown in FIG. 3.

1. System Bus Interface and DMA (#205)

The System Bus Interface and DMA Controller provide a system bus Master Interface with a two Channel DMA Controller and a system bus Slave Interface to all registers in the HardMAC. The DMA controller provides one channel for data transfers to Tx Data FIFO and one channel for data transfers from the Rx Data FIFO. The system bus Slave Interface provides address decode and read data select for HardMAC modules which have register interface and implements all logic to generate the proper response to a system bus data transfer. The slave is not split transaction capable.

2. TX PHY Data FIFO (#210)

The Tx Data FIFO provides a buffer between the system bus and the Tx PHY. This allows a block of data to be transferred to the Tx PHY and cross the system bus/Rx PHY clock boundary.

3. RX PHY Data FIFO (#215)

The Rx Data FIFO provides a storage buffer for a PLT payload. The Rx Data FIFO also crosses the clock boundary between the Rx PHY and the system bus. It packs the eight bit data from the Rx Phy into 32 bit words that are written into Rx PHY FIFO buffer. It also generates a signal when the header has been received. It also does the DA compare and generates SA and SA ready signals to the DCB CAM.

4. FCS Checker (#220)

The FCS (Frame Check Sequence) Checker calculates the 16-bit CRC of the complete incoming payload section of a received frame using a specific polynomial. A signal is generated that indicates if the CRC check was good or bad. This signal is sent to the MAC/PHY Status and Interrupt controller for use as part of the MAC/PHY status and the possible generation of an interrupt.

The last two, eight bit words written to the MAC by the Rx PHY are available in the FCS register. At the end of the payload receive, these two words contain the FCS of the current receive payload.

5. PHY Command Sequencer (#225)

The PHY Command Sequencer controls the timing and issuing of commands to the PHY from the MAC. This block is software programmable and flexible in how it operates.

The internals of this block are shown in FIG. 3 with two elements, namely Command and Control (#400) and Branch and Sequence Controls (#405).

The PHY Command Sequencer issues a command to the PHY to put the PHY in one of the defined states. The commands are set for some time before a timing pulse, called the PHY Sequence Pulse (PSP) is issued to cause the PHY to execute the command at a specified time. The commands and the PSP are issued by the processor by writing to registers or by the sequencer. The sequencer contains a defined number of entries in a table that is accessed by the Branch & Sequence Controls. These registers contain command information to the PHY and command and control information for the sequencer.

The PHY Command Sequencer consists of two basic blocks, Command & Control and Branch & Sequence Controls. The Command & Control section contains all the logic required to issue the commands and generate the PSP while the Branch & Sequence Controls contains the logic for the sequence controls and the bus interface.

The PHY Command Sequencer runs with different PHYClk rates depending on application needs and this is accomplished with synchronizer blocks.

The Branch Sequence Registers contain information that determines the next value of the sequence counter based on the inputs from the PHY or on a PSP. The registers are written over the system bus and read by the Sequence Counter (part of the PHY Command Sequencer). The location that is accessed is determined by the value of a triggering signal from the Sequence Counter. There are two possible branch destinations in each sequence register with a separate set of branch conditions for each address. The branch conditions are evaluated in the Sequence Counter.

The Command and Control Sequence Registers contain the commands to be issued to the PHY on the next PSP as well as the time for the next PSP.

The commands are sent to the PSP and Command Output Mux (in the PHY Command Sequencer) where they are multiplexed with commands from the SoftMAC Command Register (in the PHY Command Sequencer).

6. MAC/PHY Status and Interrupt Controller (#230)

The MAC/PHY Status Register and Interrupt Controller provides a single point of access to the status of the MAC/PHY and provides two interrupt signals from the MAC/PHY for use in a system interrupt controller. One interrupt, HMFIQ, is intended to be used as a high priority interrupts at the system level. The second interrupt, HMIRQ, is intended to be used as a maskable interrupt at the system level.

7. PHY Register RD/WR Interface (#235)

The system bus interface provides address decode and read data select for HardMAC modules that are resident on the system bus. The system bus will provide a single system bus select line for the system MAC/PHY.

8. DCB CAM (#240)

The DCB-CAM (content addressable memory) accelerates the location of a Destination Control Block (DCB) based on the source address of an incoming HPA frame. When a source address (SA) is provided with valid indication from Rx PHY Data FIFO, the DCB-CAM will return a pointer to the DCB associated with that source. If no match is found for the SA, the DCB-CAM will return a zero pointer.

9. Miscellaneous HardMAC Registers (#245)

The Miscellaneous HardMAC Registers contain simple registers and simple functions that do not belong in the other blocks of the HardMAC. There are three functions in the Miscellaneous HardMAC Registers. The FEC Uncorrectable Error Counter, the FEC Correctable Error Counter and the FCS Check Reset Register.

The FEC Uncorrectable Error Counter counts the number of uncorrectable FEC errors detected by the PHY while receiving a PLT frame.

The FEC Correctable Error Counter counts the number of FEC errors detected and corrected by the PHY while receiving a PLT frame.

The FCS Check Reset Register allows the SoftMAC to reset the FCS checker and all the associated registers.

References Incorporatated by Reference Herein

[1] HomePlug Alliance web site: http://www.homeplug.org
[2] “HomePlug Standard Brings Networking to the Home”; By Steve Gardner, Brian Markwalter and Larry Yonge; Communications System Design Magazine; December 2000, Vol. 16, No. 12.
[3] ETSI TS 101 867 V1.1.1 (2000-11); Technical Specification—Powerline Telecommunications (PLT); “Coexistence of Access and In-House Powerline Systems”; Reference: DTS/PLT-00004; November 2000.

1. A very flexible MAC/PHY layer controller comprising programmable pre-defined operation hardware coprocessor modules including programmable parameterized functions, wherein the programmable coprocessor modules are coupled to a general purpose processor and hardwired DSP logic.

2. The controller of claim 1, wherein the hardware module can be easily adapted to changes in regulatory, device and end-product requirements with simple software changes.

3. The controller of claim 1, wherein the hardware modules are an implementation of a PLC MAC/PHY, targeted at an in-home environment.

4. The controller of claim 1, wherein the hardware modules are an implementation of a PLC MAC/PHY, targeted at an access environment.

5. The controller of claim 1, wherein the hardware modules are an implementation of a PLC MAC/PHY, targeted at an MDU/MTU environment.

6. The controller of claim 1, wherein the hardware modules are an implementation of a MAC/PHY targeted at any communications technology.
